(19) United States
(12) Patent Application Publication
(10) Pub. No.: US 2007/0116027 A1
(43) Pub. Date: May 24, 2007

(54) DEVICE AND METHOD FOR GENERATING PRIORITY PRESERVATION COMPOSITE BURSTS, FOR A NETWORK EQUIPMENT OF A BURST SWITCHING COMMUNICATION NETWORK

(75) Inventors: Laurent CIAVAGLIA, Fontainebleau (FR); Emmanuel Dotaro, Verrieres Le Buisson (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/561,247

(22) Filed: Nov. 17, 2006

(30) Foreign Application Priority Data
Nov. 21, 2005 (FR) 0553521

(51) Int. Cl. H04L 12/56; H04L 12/28

(52) U.S. Cl. 370/412; 370/395.42

(57) ABSTRACT

A device (D) is dedicated to generating bursts of packets of data, in a network equipment (N) of a burst switching communication network. This device (D) comprises processor means (MT) adapted to generate, with a view to their transmission by the equipment (N), composite bursts assembled from packets extracted from at least two queues, including an initiator queue, associated with different classes of service and with a common packet destination, and defined in memory means (MY). To this end the processor means (MT) allocate to the different classes of service selected weights varying in a non-linear fashion as a function of associated priority levels. They then determine a linear combination of proportions of packets stored in the initiator queue and in at least one other queue associated with the same destination respectively weighted by the weights allocated to the classes of service of the packets, the result whereof preserves the priority level associated with the packets stored in said initiator queue. Finally, they assemble a composite burst to be transmitted with the packets of the linear combination.

The invention relates to communication networks, and particularly to those referred to as “data packet burst switching” networks, and more precisely to the generation of bursts of packets of data in such networks.

Here “burst switching communication networks” means all networks of the type called OBS (Optical burst-switching) or OPS (Optical Packet Switching). These OBS/OPS networks comprise all burst switching communication networks that include an optical technology at one or more locations, for example optical fibers for transmitting the packets or an optical matrix for switching the bursts.

Generally speaking, the invention being implemented at the input of a network, it therefore relates to any network capable of transmitting frames consisting of bursts of packets in accordance with the invention to their destinations, including electronically.

As the person skilled in the art knows, in the networks cited above the packets (of data) to be transmitted are first stored temporarily in queues as a function of their destination and the class of service (CoS) that is associated with them. In other words, to each queue there corresponds a (destination/class of service) pair. Each queue can store a predetermined number of packets and is associated with a maximum transmission waiting time.

If a queue is filled before its maximum transmission waiting time has passed, the packets that it contains are extracted in order to send them in the network in the form of a burst. This optimizes the transmission of the packets as a function of the priority level that is associated with their class of service.

If a queue is not filled at the expiry of its maximum transmission waiting time, the packets that it contains are also extracted and then sent in the network in the form of a burst. This leads to under-use of the resources of the network. This situation becomes all the more frequent, and therefore represents all the more of a penalty, as the number of classes of service increases. In fact, the greater the number of classes of service the fewer the number of packets stored temporarily in each queue. Consequently, either the packets must wait longer in the queues before being transmitted in the form of bursts the level of filling whereof is acceptable, or the level of filling of the bursts is low, or even very low, if the packets that they group together (or aggregate) are associated with classes of service the maximum transmission waiting time whereof is short, as is the case in particular of the class called “premium”.

In an attempt to remedy this drawback, it has been proposed, in the document by V. Vokkarane et al. “Generalized burst assembly and scheduling techniques for QoS support in Optical burst-switched networks”, Globecomm 2002, IEEE Global Telecommunications Conference, 17-21 November 2002, Taipei—Taiwan, to assemble a composite burst from packets having the same destination and associated with different classes of service (and therefore stored in different queues), each time that a queue, that will be referred to hereinafter as the “initiator” queue, is not filled at the expiry of its maximum transmission waiting time. More precisely, it has been proposed to classify the queues as a function of priority levels and to assemble a burst with the packets of the initiator queue and packets from other queues chosen as a function of their priority levels.

This solution increases the filling rate of the bursts, but does not ensure correct management of the quality of service (QoS), i.e. effective preservation of the priority level that is associated with the packets because of their respective classes of service.

No prior art solution proving entirely satisfactory, it is therefore an object of the invention to improve upon this situation, and in particular to preserve the priority levels of the packets to be transmitted.

To this end it proposes a method of generating bursts of packets of data in a burst switching communication network, said method consisting in generating, with a view to transmitting them, composite bursts constituted from packets to be transmitted extracted from at least two queues, including an initiator queue, which are dedicated to the temporary storage of packets having a common destination and associated with different classes of service.

This method is characterized in that there are allocated to the different classes of service selected weights varying in a non-linear fashion as a function of associated priority levels, after which a linear combination of proportions of packets stored in said initiator queue and in at least one other queue associated with the same destination is determined, respectively weighted by the weights allocated to the classes of service of said packets, the result whereof preserves the priority level associated with the packets stored in said initiator queue, and a composite burst is assembled to be transmitted with the packets of said linear combination.

The method of the invention may have other features, either separately or in combination, and particularly:
a linear combination may be determined the result whereof is comprised between, on the one hand, the weight allocated to the class of service whose priority level is immediately below that of the class of service associated with the initiator queue and, on the other hand, the weight allocated to the class of service associated with said initiator queue;
the packets extracted from the initiator queue may be placed at the head of the composite burst;
in the presence of first, second and third classes of service respectively associated with first, second and third priority levels, a weight from 3 to 10 may be allocated to the first class of service, a weight from 0.5 to 5 to the second class of service, and a weight from 0 to 1 to the third class of service;
for example the weight of the first class of service is equal to 5, the weight of the second class of service is equal to 1, and the weight of the third class of service is equal to 0.

The invention also proposes a device for generating bursts of packets of data, for a network equipment of a burst switching communication network, said device comprising processor means adapted to generate, with a view to their transmission by said equipment, composite bursts assembled from packets extracted from at least two queues, including an initiator queue, associated with different classes of service and with a common packet destination, and defined in memory means.

This device is characterized in that its processor means are adapted:
to allocate to the different classes of service selected weights varying in a non-linear fashion as a function of associated priority levels, then
to determine a linear combination of proportions of packets stored in said initiator queue and in at least one other queue associated with the same destination respectively weighted by the weights allocated to the classes of service of said packets, the result whereof preserves the priority level associated with the packets stored in said initiator queue, and
to assemble a composite burst, to be transmitted, with the packets of the linear combination.

The device of the invention may have other features, either separately or in combination, and particularly:
its processor means may be adapted to determine a linear combination the result whereof is comprised between, on the one hand, the weight allocated to the class of service the priority level whereof is immediately below that of the class of service associated with the initiator queue and, on the other hand, the weight allocated to the class of service associated with said initiator queue;
its processor means may be adapted to place the packets extracted from the initiator queue at the head of the composite burst;
in the presence of first, second and third classes of service respectively associated with first, second and third priority levels, its processor means may be adapted to allocate a weight from 3 to 10 to the first class of service, a weight from 0.5 to 5 to the second class of service, and a weight from 0 to 1 to the third class of service;
for example, the weight of the first class of service is equal to 5, said weight of the second class of service is equal to 1, and said weight of the third class of service is equal to 0;
it may comprise the memory means in which the queues are defined.

The invention also proposes a network equipment for a burst switching communication network, comprising a device for generating bursts of packets of data of the same type as that described hereinabove.

The invention is particularly well adapted, although not exclusively so, to Internet Protocol (IP) communication networks. However, as indicated in the introduction, the invention applies to any transport network that aggregates (client) packets into bursts of packets having the same destination.

Other features and advantages of the invention will become apparent on reading the following detailed description and examining the appended drawings, in which:

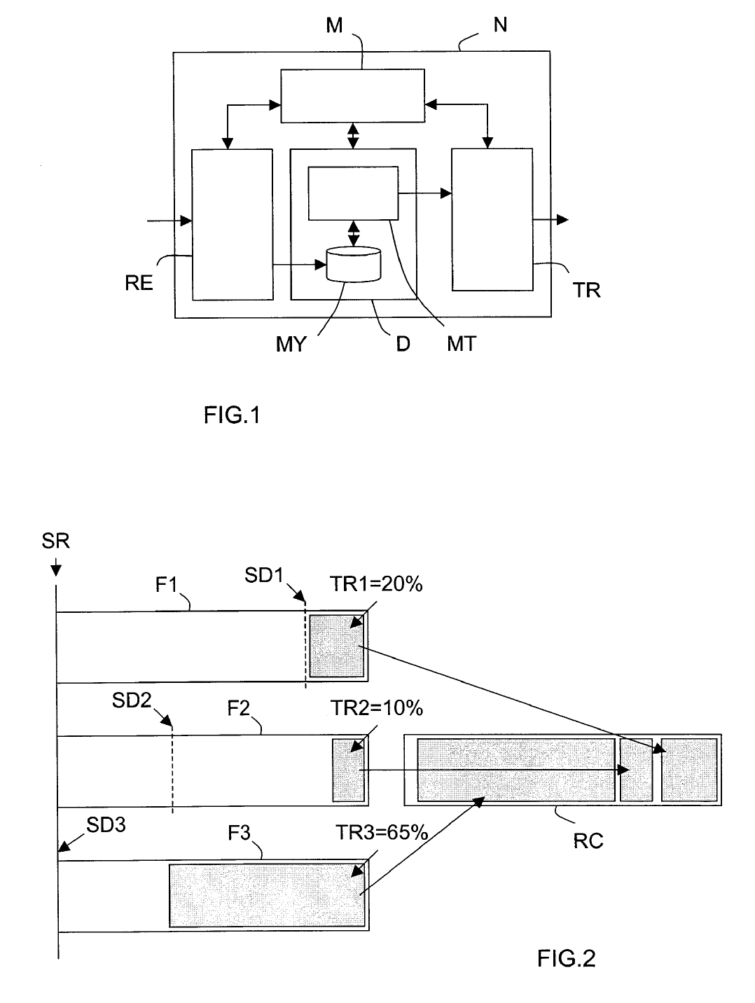

FIG. 1 is a functional diagram of one example of a node equipped with one embodiment of a device in accordance with the invention for generating bursts of packets of data, and

FIG. 2 is a diagram of one example of the generation of composite bursts in accordance with the invention, in the presence of three different classes of service.

The appended drawings constitute part of the description of the invention as well as contributing to the definition of the invention, if necessary.

An object of the invention is to optimize, in a burst switching communication network of the OBS or OPS type, the filling rate of the bursts of packets of data in a way that preserves the priority levels of the packets to be transmitted.

It is considered hereinafter by way of nonlimiting example that the network is an Internet Protocol (IP) network that switches packets (of data). However, the invention is not limited to that application. It relates in fact to burst switching of data packets regardless of the type of protocol used to transport them.

It will be noted that in the context of burst switching networks, the IP packets are the client packets, and therefore those that are aggregated in the bursts. The protocol or the type of network for transporting the bursts is neither fixed nor standardized. These are often networks based on proprietary architectures or based in part on standardized protocols such as the G.ASON or G.709 (OTN) standards of the ITU-T (International Telecommunication Union—Telecommunication standardization).

Broadly speaking, but nevertheless in sufficient detail for the invention to be understood, a switching network may be summarized as a multiplicity of network equipments defining nodes, such as switches or routers, which are coupled to each other. The nodes set up connection paths (also called switching paths) within the network, generally when they are situated at the periphery of the network, or simply switch the packets that pass in transit through them.

As shown diagrammatically and functionally in FIG. 1, a network equipment N of the node type includes, firstly, a receiver module RE for receiving the IP packets in transit, secondly, a transmitter module TR for transmitting to another node of the network the IP packets in transit or added locally after having switched them, and, thirdly, a control module MC for controlling the operation of the receiver modules RE and the transmitter modules TR, and particularly for configuring the switching means of the transmitter module TR, as well as, where applicable, managing the dropping of IP packets at the level of the receiver module RE and the adding of IP packets in the transmitter module TR, as a function of instructions received from the network.

It will be noted that in networks of the OBS or OPS type, the client packets are generally aggregated into bursts at the input (or periphery) of the network. Once the burst has been assembled, it is not modified further (there is therefore no adding or dropping of client IP packets in the intermediate nodes). The burst is routed in the network (passing in transit through intermediate nodes) to its destination, where it is disassembled to retrieve the client IP packets which are then transmitted externally of the OBS/OPS network. There nevertheless exist architectures in which the bursts can be modified while en route. The invention applies equally to that type of architecture.

In an IP packet burst switching network, at least some of the nodes (or network equipments) N further comprise a burst generator device D and a memory MY, generally of the buffer type. In fact, in burst switching networks, the aggregation function (implemented by the device D) is present in all the nodes, whether they are situated at the periphery of the network or not, because all the nodes may be entry/exit points for a given traffic. Consequently, a device D may be used whenever a traffic enters (or leaves) a burst switching network.

The memory MY is coupled to the receiver module RE. As shown in FIG. 1, it may be part of the device D. This is not obligatory, however.

Each time that the receiver module RE receives IP packets it determines their destination dk and the class of service (CoS) Ci that is associated with them, with i=2 to M and k=1 to P.

Here “class of service” means a class grouping together services that must be provided by the network to transport packets coming from clients in accordance with a chosen quality of service (QoS). To each class of service Ci there corresponds a transmission priority level.

Three classes of service may be cited, for example (M=3): the “premium” class, the “medium” class and the “standard” (or “best effort”) class. The premium class is that which benefits from the highest priority level. It often corresponds to a fixed and reserved bandwidth over the whole of the connection path. The medium class is that which benefits from the intermediate priority level. It often corresponds to a reserved bandwidth that may vary along a connection path. The standard class is that which benefits from the lowest priority level. The corresponding bandwidth is not reserved. In fact, IP packets associated with this standard class are transmitted with the available (unreserved) bandwidth.

It is important to note that the invention is not limited to the above three classes of service. It applies whenever the number of different classes of service is greater than or equal to two.

When the receiver module RE knows the destination dk and the class of service of an IP packet, it stores it in a queue Fj (j=1 to M×P) defined in the memory MY and dedicated to that destination dk and that class of service Ci.

Each queue Fj is therefore associated with a pair consisting of a destination dk and a class of service Ci. All the packets that are associated with the same pair are stored in the queue Fj dedicated to that pair, provided that it is not full. In fact, each queue Fj can store only a predefined maximum number SR of IP packets. The maximum number SR is the same for all the queues Fj, for example, as shown in FIG. 2. However, this is not obligatory.

If a received IP packet is associated with a pair for which there is not yet a queue Fj in the memory MY, the receiver module RE creates a new queue dedicated to that new pair in the memory MY, in order to store the IP packet temporarily therein.

Each queue Fj is also associated with a maximum transmission waiting time SDj. This is the maximum time for which IP packets can wait in a queue Fj before being transmitted in a burst, given the class of service that is associated with them. The higher the priority level of a class of service, the shorter the maximum transmission waiting time SDj. The maximum transmission waiting time SDj of a queue Fj is defined temporally relative to the date of creation of that queue Fj, which corresponds substantially to the time at which its first packet IP is stored.

When a queue Fj is emptied of its packets (because they have been integrated into a transmitted burst), it is deleted from the memory MY immediately or retained to store temporarily future IP packets associated with its parameter pair (destination/class of service) or retained for a selected time period and then deleted. A cache memory mechanism may be used for virtual retention of the empty queues.

The generator device D of the invention is coupled to the memory MY (if the latter is not part of it) and to the control module MC from which it receives instructions.

The node N having also to manage the packets in transit and therefore the associated queues, it may therefore incorporate the device D, the memory MY and the module MC in a “functional supersystem” for managing the (“scheduling”—programming) service for all the queues of the node N.

The generator device D includes at least one processor module MT for executing three tasks.

The first task consists in allocating each class of service Ci a selected weight Wi. The weights Wi vary in a non-linear manner from one class of service Ci to another Ci′ as a function of their respective associated priority levels. These weights Wi are defined by the network operator. For example, they are transmitted to the processor module MT via the control module of the node N in which the device D is installed.

The non-linear variation of the weights Wi is intended to preserve the difference between services within the network, and in particular the transmission priority levels (see below).

For example, if there are only the three classes of service referred to above (premium (C1), medium (C2) and standard (C3)), respectively associated with first, second and third priority levels, the processor module MT may assign a weight W1 from 3 to 10 to the premium class C1, a weight W2 from 0.5 to 5 to the medium class C2, and a weight W3 from 0 to 1 to the standard class C3.

In one nonlimiting example, the weight W1 of the premium class C1 is equal to 5, the weight W2 of the medium class C2 is equal to 1, and the weight W3 of the standard class is equal to 0.

The values given above are merely illustrative. As a general rule, the weight values allocated to the different classes of service depend on the quality of service (QoS) parameters at the entry and exit of the network. What is important is that the values guarantee that in most traffic situations the composite burst has a composite class of service conforming to the levels of service. To this end, and when there are three classes of service, a logarithmic scale may be used, for example. With more than three classes of service, it is preferable to use a different non-linear scale, one that is less severe than the logarithmic scale.

The second task of the processor module MT is to access the memory MY in order to determine at least one linear combination CL of proportions (or percentages) Pj of packets, stored in an initiator queue and in at least one other queue associated with the same destination, respectively weighted by the weights Wi assigned to the classes of service Ci of those packets, the result whereof preserves the priority level that is associated with the packets stored in the initiator queue.

Here “initiator queue” means a queue Fj that is not filled at the expiry of its maximum transmission waiting time SDj. This is the situation, for example, of the first queue F1, associated with the premium class C1, shown in FIG. 2.

Each time that the processor module MT realizes that an initiator queue exists, it executes a second task to enable the generation (by a third task) of a composite burst RC to be transmitted integrating the packets IP stored in particular in that initiator queue. To do this, a procedure for triggering an alarm in the event of a temporal threshold overshoot (SDj) may be used, for example.

To effect its linear combinations, the processor module may start by determining the filling rate TRj of each queue Fj.

If the sum of the filling rates TRj is less than or equal to 100%, then the processor module MT retains each filling rate TRj and uses it as the proportion Pj for effecting a linear combination. If there are only three queues Fj (associated with the class Ci of weight Wi), Fj′ (associated with the class Ci′ of weight Wi′), and Fj″ (associated with the class Ci″ of weight Wi″), the linear combination is then defined by the equation CL=TRj*Wi+TRj′*Wi′+TRj″*Wi″.

If the result of the linear combination CL, called the composite weight, is between, on the one hand, the weight allocated to the class of service whose priority level is immediately below that of the class of service associated with the initiator queue and, on the other hand, the weight assigned to the class of service associated with the initiator queue, then the processor module MT retains that linear combination to generate a composite burst RC, because this means that the priority level of the packets to be transmitted will be complied with.

If not, the processor module MT must determine a new linear combination that satisfies the criterion cited above using the filling rate TRj of the initiator queue Fj (because it is its packets that must be transmitted immediately) and one or more fractions of filling rates of other queues associated with the same destination as Fj.

In other words, the processor module MT determines the proportion Pj′ of each queue Fj′ that it can use for the result (or composite weight) of the linear combination using the filling rate TRj of the initiator queue Fj and the proportions Pj′ to satisfy the criterion cited above. For example if W3<W2<W1, and if W2 is the weight of the class of service C2 associated with the initiator queue F2, then we must have W3<CL≦W2.

If the sum of the filling rates TRj of the queues associated with the same destination is greater than 100%, this means that we cannot use all the IP packets that are stored in the queues associated with the same destination as the initiator queue. Consequently, the processor module MT must determine a linear combination that uses the filling rates TRj of the initiator queue Fj (because it is its packets that must be transmitted immediately) and one or more fractions of filling rates of other queues associated with the same destination as Fj. For example, CL=P1*W1+P2*W2, with P1=TR1, P2=TR2 or P2=f(TR2) [selected fraction of TR2], or CL=P1*W1+P2*W2+P3*W3, with P1=TR1, P2=TR2 or P2=f(TR2), and P3=f(TR3) or P3=TR3.

If a first linear combination does not satisfy the criterion cited above then the processor module MT must try a new one, with new proportions for at least some of the queues associated with the same destination as Fj.

In the example illustrated in FIG. 2, the initiator queue is the first queue F1, which is associated with the highest priority level and the filling rate TR1 whereof is equal to 20% when its maximum transmission waiting time SD1 expires, at which time the other queues F2 and F3, associated with the same destination as F1 and respectively with the intermediate priority level and the lowest priority level, have filling rates TR2 and TR3 equal to 10% and 65%, respectively. The sum of the three filling rates (TR1+TR2+TR3) being here equal to 95%, the processor module MT therefore retains them to effect its linear combination: CL=TR1*W1+TR2*W2+TR3*W3. For example if W1=5, W2=1 and W3=0, then CL=1.1 (5*0.2+1*0.1+0*0.65).

In this case, the criterion is satisfied because it is indeed the case that W2 (=1)<CL(=1.1)≦W1 (=5).

In another example using the same values Wj as above, but filling rates TR1, TR2 and TR3 equal to 5%, 60% and 20%, respectively, we obtain CL=0.85 (5*0.05+1*0.6+0*0.2). In this case, the criterion is not satisfied because CL (=0.85)<W2 (=1). The criterion would be satisfied, on the other hand, if the initiator queue were F2 and not F1.

An embodiment of the invention is described above in which the processor module MT determines a linear combination taking account of all the queues associated with the same destination as the initiator queue. However, this is not obligatory. In fact certain restrictions may be imposed on the processor module MT. Thus the use in a composite burst RC of packets stored in the queues associated with the classes of service having the highest two priority levels may be prohibited, for example.

Once the processor module MT has determined a linear combination that satisfies the criterion, it carries out the third task. This consists in extracting from the queues Fj the proportions Pj of the packets that were used to determine the linear combination, and then assembling a composite burst RC with these extracted packets.

One example of a composite burst RC is illustrated in FIG. 2. In this example, the composite burst RC is constituted of 20% of packets associated with the premium class C1, 10% of packets associated with the medium class C2 and 65% of packets associated with the standard class C3.

The processor module MT then transmits the composite burst RC to the transmitter module TR in order for it to transmit it to the next node of the connection path provided for transporting it.

Each queue Fj, emptied of its packets (because they have been integrated into the composite burst transmitted), is eliminated from the memory MY immediately, or retained to store temporarily future IP packets associated with its parameter pair (destination/class of service) or retained for a selected period and then eliminated. This depends on the embodiment. When an elimination must be effected, it is for example the processor module MT of the device D or the control module MC of the node N that initiates it. This also depends on the embodiment.

The processor module MT preferably places the packets that it has extracted from the initiator queue and which must be transmitted first at the head of the composite burst RC. The packets extracted from the other queues are then placed for preference behind those from the initiator queue as a function of the priority levels that are respectively associated with them. They are preferably placed as a function of a decreasing order of priority level.

There has been described above the situation in which the processor module MT generates a composite burst RC because a queue is not filled at the expiry of its maximum transmission waiting time. However, if a queue is filled before its maximum transmission waiting time has passed, the processor module MT conventionally extracts the packets that it contains in order to send them in the network in the form of a non-composite burst.

The processor module MT, and where applicable the memory MY, may be produced in the form of electronic circuits, software (or electronic data processing) modules, or a combination of circuits and software.

There has been described above an embodiment of the invention in the form of a device D for generating bursts of data packets. However, the invention also takes the form of a method of generating bursts of data packets, of the type described in the introduction, and the steps whereof can in particular be executed by the device D.

The invention is not limited to the data packet burst generation device and network equipment embodiments described above by way of example only, but encompasses all variants that the person skilled in the art might envisage within the scope of the following claims.

1. Method of generating bursts of packets of data in a burst switching communication network, said method comprising generation, so as to be transmitted, of composite bursts constituted from packets to be transmitted extracted from at least two queues, including an initiator queue, which are dedicated to the temporary storage of packets having a common destination and associated with different classes of service, characterized in that there are allocated to the different classes of service selected weights varying in a non-linear fashion as a function of associated priority levels, after which a linear combination of proportions of packets stored in said initiator queue and in at least one other queue associated with the same destination is determined, respectively weighted by the weights allocated to the classes of service of said packets, the result of which preserves the priority level associated with the packets stored in said initiator queue, and a composite burst is assembled to be transmitted with the packets of said linear combination.

2. Method according to claim 1, characterized in that a linear combination is determined the result whereof is comprised between, on the one hand, the weight allocated to the class of service whose priority level is immediately below that of the class of service associated with the initiator queue and, on the other hand, the weight allocated to the class of service associated with said initiator queue.

3. Method according to claim 1, characterized in that the packets extracted from the initiator queue are placed at the head of the composite burst.

4. Method according to claim 1, characterized in that in the presence of first, second and third classes of service respectively associated with first, second and third priority levels, a weight from 3 to 10 is allocated to the first class of service, a weight from 0.5 to 5 to the second class of service, and a weight from 0 to 1 to the third class of service.

5. Method according to claim 4, characterized in that said weight of the first class of service is equal to 5, said weight of the second class of service is equal to 1, and said weight of the third class of service is equal to 0.

6. Device (D) for generating bursts of packets of data, for a network equipment (N) of a burst switching communication network, said device (D) comprising processor means (MT) adapted to generate, so as to be transmitted by said equipment (N), composite bursts assembled from packets extracted from at least two queues, including an initiator queue, which are associated with different classes of service and with a common packet destination, and defined in memory means (MY), characterized in that said processor means (MT) are adapted i) to allocate to the different classes of service selected weights varying in a non-linear fashion as a function of associated priority levels, then ii) to determine a linear combination of proportions of packets, stored in said initiator queue and in at least one other queue associated with the same destination, respectively weighted by the weights allocated to the classes of service of said packets, the result of which preserves the priority level associated with the packets stored in said initiator queue, and iii) to assemble a composite burst to be transmitted with the packets of said linear combination.

7. Device according to claim 6, characterized in that said processor means (MT) are adapted to determine a linear combination the result whereof is comprised between, on the one hand, the weight allocated to the class of service the priority level whereof is immediately below that of the class of service associated with the initiator queue and, on the other hand, the weight allocated to the class of service associated with said initiator queue.

8. Device according to claim 6, characterized in that said processor means (MT) are adapted to place the packets extracted from the initiator queue at the head of the composite burst.

9. Device according to claim 6, characterized in that in the presence of first, second and third classes of service respectively associated with first, second and third priority levels, said processor means (MT) are adapted to allocate a weight from 3 to 10 to the first class of service, a weight from 0.5 to 5 to the second class of service, and a weight from 0 to 1 to the third class of service.

10. Device according to claim 9, characterized in that said weight of the first class of service is equal to 5, said weight of the second class of service is equal to 1, and said weight of the third class of service is equal to 0.

11. Device according to claim 6, characterized in that it comprises said memory means (MY).

12. Network equipment (N) for a burst switching communication network, characterized in that it comprises a device (D) for generating bursts of packets of data according to claim 6.
